(19) United States
(12) Patent Application Publication
(10) Pub. No.: US 2025/0220132 A1
(43) Pub. Date: Jul. 3, 2025

(54) COOKING APPLIANCE THAT PROVIDES TIME-LAPSE VIDEO AND CONTROLLING METHOD THEREOF

(71) Applicant: SAMSUNG ELECTRONICS CO., LTD., Suwon-si (KR)

(72) Inventor: Seongjin HONG, Suwon-si (KR)

(73) Assignee: SAMSUNG ELECTRONICS CO., LTD., Suwon-si (KR)

(21) Appl. No.: 19/082,410

(22) Filed: Mar. 18, 2025

Related U.S. Application Data
(63) Continuation of application No. PCT/KR2023/015627, filed on Oct. 11, 2023.

(30) Foreign Application Priority Data
Oct. 27, 2022 (KR) 10-2022-0140684

(51) Int. Cl. H04N 5/783; G06T 3/60

(52) U.S. Cl. CPC H04N 5/783; G06T 3/60

(57) ABSTRACT

An electronic apparatus including a cooking chamber in which an inner chamber is rotatable, a camera, a memory, and at least one processor. The at least one processor is configured to, based on cooking being started, obtain a reference image of an inside of the cooking chamber, obtain a plurality of images of the inside of the cooking chamber at a preset time interval while the inner chamber rotates in a first direction, store the plurality of images in association with a rotation angle of the inner chamber at a time the plurality of images are captured, respectively, obtain a plurality of rotated images by rotating the plurality of images in a second direction, opposite to the first direction, by a rotation angle stored, obtain a plurality of cropped images based on the reference image, and provide a time-lapse video using the reference image and the plurality of cropped images.

### CROSS-REFERENCE TO RELATED APPLICATION

This application is a continuation application, under 35 U.S.C. § 111(a), of international application No. PCT/KR2023/015627, filed Oct. 11, 2023, which claims priority under 35 U. S. C. § 119 to Korean Patent Application No. 10-2022-0140684, filed Oct. 27, 2022, the disclosures of which are incorporated herein by reference in their entireties.

### Technical Field

The present disclosure relates to a cooking appliance and a controlling method thereof, and more particularly to, a cooking appliance that provides a time-lapse video and a controlling method thereof.

### Background Art

A cooking appliance can perform various cooking functions such as baking, frying, boiling, and the like. In general, the prior art cooking appliance may perform can heat food at a heating temperature set by a user.

In this case, the cooking appliance may provide a time-lapse video generated by capturing the image of cooking food.

In the case of a cooking appliance with a rotating inner chamber, there is a problem that it is difficult for the user to identify the cooking degree of the food because the food included in the time-lapse video is not fixed in the same position.

### Disclosure

### Technical Solution

An electronic apparatus according to an embodiment includes a cooking chamber in which an inner chamber is rotatable, a camera, a memory to store at least one instruction, and at least one processor to be connected to the memory to control the cooking appliance, and the at least one processor, by executing the at least one instruction, is configured to, based on cooking being started, obtain a reference image of an inside of the cooking chamber captured by the camera, obtain a plurality of images of the inside of the cooking chamber captured by the camera at a preset time interval while the inner chamber rotates in a first direction, store the plurality of images by matching the plurality of images with a rotation angle of the inner chamber at a time when the plurality of images are captured, respectively, obtain a plurality of rotated images by rotating the plurality of images in a second direction by a rotation angle stored that matches the plurality of images, the second direction being opposite to the first direction, obtain a plurality of cropped images by cropping the plurality of rotated images such that the plurality of rotated images correspond to the reference image, and provide a time-lapse video using the reference image and the plurality of cropped images.

A controlling method of an electronic apparatus according to an embodiment includes, based on cooking being started, obtaining a reference image of an inside of a cooking chamber captured by the camera, obtaining a plurality of images of the inside of the cooking chamber captured by the camera, at a preset time interval while an inner chamber of the cooking chamber rotates in a first direction, storing the plurality of images by matching the plurality of images with a rotation angle of the inner chamber at a time when the plurality of images are captured, respectively, obtaining a plurality of rotated images by rotating the plurality of images in a second direction by a rotation angle stored that matches the plurality of images, the second direction being opposite to the first direction, obtaining a plurality of cropped images by cropping the plurality of rotated images such that the plurality of rotated images correspond to the reference image, and providing a time-lapse video using the reference image and the plurality of cropped images.

In a non-transitory computer-readable recording medium including a program that executes a controlling method of an electronic apparatus according to an embodiment, the controlling method includes based on cooking being started, obtaining a reference image of an inside of a cooking chamber captured by the camera, obtaining a plurality of images of the inside of the cooking chamber captured by the camera at a preset time interval while an inner chamber of the cooking chamber rotates in a first direction, storing the plurality of images by matching the plurality of images with a rotation angle of the inner chamber at a time the plurality of images are captured, respectively, obtaining a plurality of rotated images by rotating the plurality of images in a second direction by a rotation angle stored that matches the plurality of images, the second direction being opposite to the first direction, obtaining a plurality of cropped images by cropping the plurality of rotated images such that the plurality of rotated images correspond to the reference image, and providing a time-lapse video using the reference image and the plurality of cropped images.

### Description of Drawings

FIG. 1 is a block diagram provided to explain configuration of a cooking appliance according to an embodiment;

FIG. 2 is a view provided to explain a reference image according to an embodiment;

FIGS. 3A, 3B, 3C, 3D, 3E to 3F are views provided to explain a method of obtaining a plurality of images in which a cooking appliance is corrected according to an embodiment;

FIG. 4 is a view provided to explain an operation of a cooking appliance according to an embodiment;

FIG. 5 is a view provided to explain a time-lapse video according to an embodiment;

FIG. 6 is a sequence view provided to explain a method of controlling a user terminal device by a cooking appliance according to an embodiment; and

FIG. 7 is a flowchart provided to explain a controlling method of a cooking appliance according to an embodiment.

### DETAILED DESCRIPTION OF EMBODIMENTS

The embodiments of the present disclosure may be modified in various ways, and may have various embodiments, so specific embodiments are illustrated in the drawings and described in detail in the detailed description. However, it is to be understood that the disclosure is not limited to specific exemplary embodiments, but include all modifications, equivalents, and/or alternatives according to exemplary embodiments of the disclosure. Throughout the description of the accompanying drawings, similar components may be denoted by similar reference numerals.

In describing the disclosure, when it is decided that a detailed description for the known functions or configurations related to the disclosure may unnecessarily obscure the gist of the disclosure, the detailed description therefor will be omitted.

In addition, the following exemplary embodiments may be modified in several different forms, and the scope of the technical spirit of the disclosure is not limited to the following exemplary embodiments. Rather, these exemplary embodiments make the disclosure thorough and complete, and are provided to completely transfer the spirit of the disclosure to those skilled in the art.

Terms used in the disclosure are used only to describe specific exemplary embodiments rather than limiting the scope of the disclosure. Singular forms are intended to include plural forms unless the context clearly indicates otherwise.

In the disclosure, the expressions “have”, “may have”, “include” or “may include” used herein indicate existence of corresponding features (e.g., elements such as numeric values, functions, operations, or components), but do not exclude presence of additional features.

In the disclosure, the expressions “A or B”, “at least one of A or/and B”, or “one or more of A or/and B”, and the like may include any and all combinations of one or more of the items listed together. For example, the term “A or B”, “at least one of A and B”, or “at least one of A or B” may refer to all of the case (1) where at least one A is included, the case (2) where at least one B is included, or the case (3) where both of at least one A and at least one B are included.

Expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

On the other hand, when an element (e.g., a first element) is referred to as being “directly coupled with/to” or “directly connected to” another element (e.g., a second element), it should be understood that there is no intervening element (e.g., a third element) in-between.

An expression “˜configured (or set) to” used in the disclosure may be replaced by an expression, for example, “suitable for,” “having the capacity to,” “˜designed to,” “˜adapted to,” “˜made to,” or “˜capable of” depending on a situation. A term “˜configured (or set) to” may not necessarily mean “specifically designed to” in hardware.

Instead, an expression “˜an apparatus configured to” may mean that an apparatus “is capable of” together with other apparatuses or components. For example, a “processor configured (or set) to perform A, B, and C” may mean a dedicated processor (e.g., an embedded processor) for performing the corresponding operations or a generic-purpose processor (e.g., a central processing unit (CPU) or an application processor) that may perform the corresponding operations by executing one or more software programs stored in a memory device.

In exemplary embodiments, a ‘module’ or a ‘˜er’ may perform at least one function or operation, and be implemented as hardware or software or be implemented as a combination of hardware and software. In addition, a plurality of ‘modules’ or a plurality of ‘˜er’ may be integrated into at least one module and be implemented as at least one processor except for a ‘module’ or a ‘˜er’ that needs to be implemented as specific hardware.

Meanwhile, various elements and areas in the drawings are schematically drawn in the drawings. Therefore, the technical concept of the disclosure is not limited by a relative size or spacing drawn in the accompanying drawings.

Hereinafter, an embodiment according to the present disclosure will be described in detail with reference to the accompanying drawings so that a person with ordinary knowledge in the technical field to which the present disclosure belongs can easily implement the present disclosure.

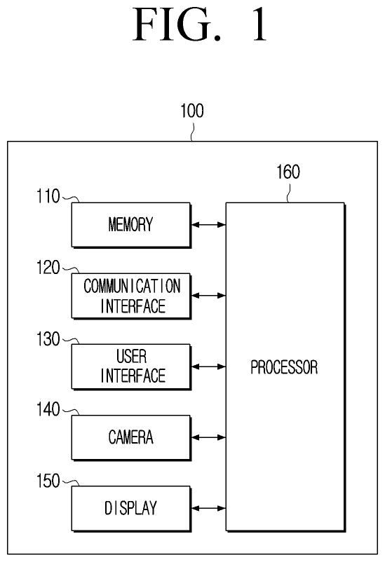

FIG. 1 is a block diagram provided to explain configuration of a cooking appliance according to an embodiment.

Referring to FIG. 1, a cooking appliance 100 may include memory 110, a communication interface 120, a user interface 130, a camera 140, a display 150, and a processor 160. Some of the above components of the cooking appliance 100 may be omitted, and other components may be further included.

While the cooking appliance 100 may be implemented as a microwave oven, this is only an example, and the cooking appliance 100 may be implemented as various types of cooking appliance such as an oven, air fryer, etc.

In this case, the cooking appliance 100 may include a cooking chamber with a rotating inner chamber. Specifically, the cooking chamber may include a rotating dish installed on the bottom surface on which food or a cooking vessel containing food is placed. In this case, when the food is being cooked, the rotating dish inside the cooking chamber may rotate.

The memory 110 may store at least one instruction for the cooking appliance 100. The memory 110 may store an operating system (O/S) for operating the cooking appliance 100. Further, the memory 110 may store various software programs or applications for operating the cooking appliance 100 in accordance with various embodiments of the present disclosure. The memory 110 may include semiconductor memory such as flash memory, or a magnetic storage medium such as a hard disk, or the like.

Specifically, the memory 110 may store various software modules for operating the cooking appliance 100 according to various embodiments of the present disclosure, and the processor 160 may control the operation of the cooking appliance 100 by executing various software modules stored in the memory 110. In other words, the memory 110 may be accessed by the processor 160, and the data may be read/written/modified/deleted/updated, etc. by the processor 160.

Meanwhile, the term ‘memory 110’ in this disclosure may be used to include the memory 110, ROM or RAM in the processor 160, or a memory card (e.g., micro SD card, memory stick) mounted in the cooking appliance 100.

In particular, the memory 110 may store information about an artificial intelligence model including a plurality of layers. Here, storing information about the artificial intelligence model may mean storing various information related to the operation of the artificial intelligence model, such as information about a plurality of layers included in the artificial intelligence model, information about parameters utilized by each of the plurality of layers (e.g., filter coefficients, biases, etc.), and the like.

In this case, the artificial intelligence model could be a neural network that, when an image is input, outputs the cooking degree of the food included in the image.

The communication interface 120 includes circuitry and is configured to perform communication with an external device and a server. The communication interface 120 may perform communication with an external device or a server based on wired or wireless communication methods. In this case, the communication interface 120 may include a Bluetooth module (not shown), a Wi-Fi module (not shown), an infrared (IR) module, a Local Area Network (LAN) module, an Ethernet module, etc. Here, each communication module may be implemented in the form of at least one hardware chip. In addition to the above- described communication methods, at least one communication chip that performs communication according to various wireless communication standards, such as Zigbee, Universal Serial Bus (USB), Mobile Industry Processor Interface Camera Serial Interface (MIPI CSI), 3rd Generation (3G), 3rd Generation Partnership Project (3GPP), Long Term Evolution (LTE), LTE advanced (LTE-A), 4th Generation (4G), 5th Generation (5G), etc. may be included. However, this is only an example, and the communication interface 120 may use at least one communication module among various communication modules.

The user interface 130 is configured to receive a user command for controlling the cooking appliance 100. The user interface 130 may be implemented as a button, a touch pad, a mouse, a keyboard, etc., or may be implemented as a touch screen capable of performing a display function and a manipulation input function. Here, the button may be various types of buttons such as a mechanical button, a touch pad, a wheel, etc. formed in any arbitrary area of the exterior of the main body of the cooking appliance 100, such as the front, side, or back. The cooking appliance 100 may obtain various user inputs via the user interface 130.

The camera 140 may capture images and videos. According to various embodiments, a camera module may include one or more lenses, an image sensor, an image signal processor, or a flash.

Further, the camera 140 may obtain an image by capturing an inside of the cooking chamber while food located within the cooking chamber is being cooked.

The display 150 may be implemented as a display including a self-luminous element or a display including a non-luminous element and a backlight. For example, the display 150 may be implemented as various types of displays such as a Liquid Crystal Display (LCD), an Organic Light Emitting Diodes (OLED) display, a Light Emitting Diodes (LED), a micro LED, a Mini LED, a Plasma Display Panel (PDP), a Quantum dot (QD) display, a Quantum dot light-emitting diodes (QLED), etc. The display 150 may also include a driving circuit, a backlight unit, and the like, which may be implemented in the form of a-si TFTs, low temperature poly silicon (LTPS) TFTs, organic TFTs (OTFTs), and the like.

The processor 160 may control the overall operations and functions of the cooking appliance 100. Specifically, the processor 160 is connected to a configuration of the cooking appliance 100 that includes the memory 110, and may control the overall operations of the cooking appliance 100 by executing at least one instruction stored in the memory 110, as described above.

The processor 160 may be implemented in various ways. For example, the processor 160 may be implemented as at least one of Application Specific Integrated Circuit (ASIC), embedded processor, microprocessor, hardware control logic, hardware Finite State Machine (FSM), or Digital Signal Processor (DSP). Meanwhile, the term ‘processor 160’ in this disclosure may be used to include a Central Processing Unit (CPU), a Graphic Processing Unit (GPU), a Micro Processor Unit (MPU), and the like.

The operation of the processor 160 for implementing various embodiments of the present disclosure may be implemented through a plurality of modules.

Specifically, data for the plurality of modules according to the present disclosure may be stored in the memory 110, and processor 160 may access the memory 110 to load data for the plurality of modules into the memory or buffer within processor 160, and then use the plurality of modules to implement various embodiments of the present disclosure.

However, at least one of the plurality of modules according to the present disclosure may also be implemented in hardware and included within the processor 160 in the form of a system on chip.

The processor 160 may obtain a user input for generating a time-lapse video. In this case, the time-lapse video may be a video generated using a plurality of images of food while the food is being cooked. In addition, the time-lapse video may be a video in which the difference in shooting time between images included in the time-lapse video is greater than the difference in playback time. For example, the difference in shooting time between images included in the time-lapse video may be 10 seconds, and the difference in playback time may be 0.1 seconds.

Further, the time-lapse video may be stored as a file including a plurality of images. For example, the time-lapse video may be compressed according to a standard such as Moving Picture Experts Group 4 (MPEG4), H.264/AVC, or windows media video (WMV), and the compressed images may be stored as a video file. The time-lapse video file may be generated in various formats such as mpg, mp4, 3fpp, avi, asf, mov, etc.

The user input for generating a time-lapse video may include at least one of information about whether to generate the time-lapse video, a shooting interval between images included in the time-lapse video, or a playback time of the time-lapse video.

In this case, the processor 160 may obtain the user input for generating a time-lapse video via the user interface 130 or the communication interface 120.

Specifically, the processor 160 may obtain the user input for generating a time-lapse video from a user terminal device via the communication interface 120.

Alternatively, the user may transmit a signal to the server for controlling the cooking appliance 100 to generate a time-lapse video via an application installed on the user terminal device. Subsequently, the processor 160 may transmit the signal for controlling the cooking appliance 100 to generate a time-lapse video from the server to the cooking appliance 100 via the communication interface 120.

The processor 160 may obtain a user input for starting cooking via the user interface 130 or the communication interface 120.

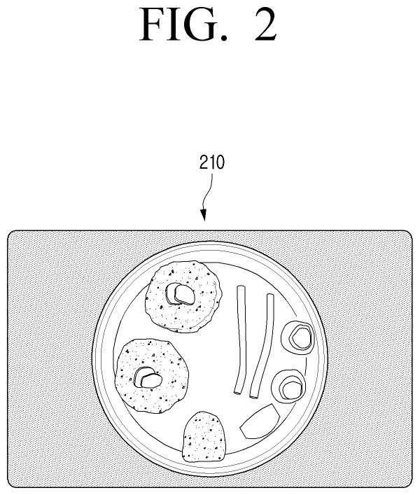

When cooking starts, the processor 160 may obtain a reference image by capturing an inside of the cooking chamber. In this case, the reference image may be the same as an image 210 shown in FIG. 2.

While the cooking chamber is rotating in the first direction, the processor 160 may obtain a plurality of images by capturing the inside of the cooking chamber at a preset time interval. In this case, the preset time interval may be a value stored in the memory 110 or a value obtained via the communication interface 120 or the user interface 130.

For example, the processor 160 may obtain a plurality of images by capturing the inside of the cooking chamber at 10-second intervals while the inner chamber is rotating clockwise.

The processor 160 may then match each of the plurality of images with a rotation angle of the inner chamber at the time when each of the plurality of images is captured and store the images in the memory 110.

In this case, the rotation angle of the inner chamber at the time when each of the plurality of images is taken may mean the angle at which the inner chamber rotates from the time when the reference image is captured to the time when each of the plurality of images is taken. In this case, the rotation angle of the inner chamber may mean the rotation angle of a rotating dish placed in the cooking chamber.

Specifically, the memory 110 may include information about an angular velocity of rotation of the inner chamber. In addition, based on the information about the angular velocity of rotation of the inner chamber stored in the memory 110, the processor 160 may obtain information about the angle at which the inner chamber rotates from the time when the reference image is obtained to the time when each of the plurality of images is captured.

For example, the rotational angular velocity of the inner chamber may be 10 degrees per second. In this case, when the first image among the plurality of images is captured 10 seconds after the reference image is captured, the rotation angle of the inner chamber at the time when the first image is captured may be 100 degrees. In this case, the processor 160 may match the first image with 100 degrees and store it.

Alternatively, when the second image among the plurality of images is captured 20 seconds after the reference image is captured, the rotation angle of the inner chamber at the time when the second image is captured may be 200 degrees. In this case, the processor 160 may match the second image with 200 degrees and store it.

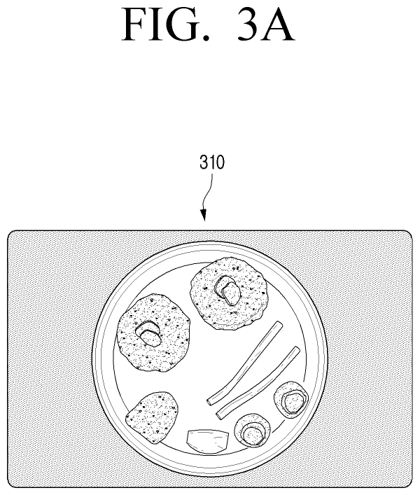

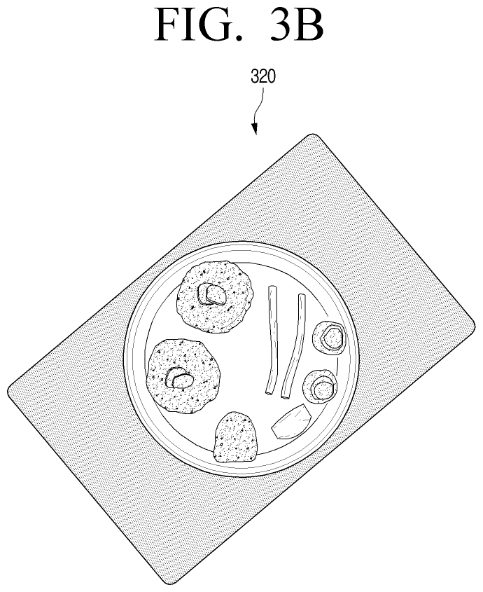

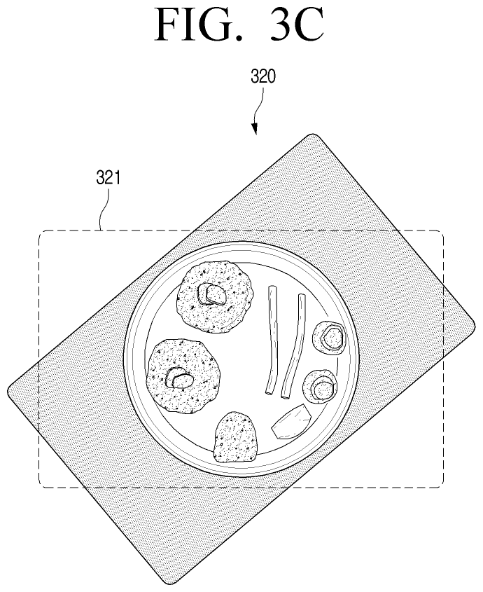

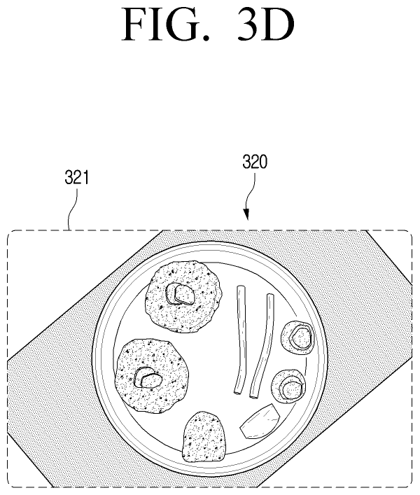

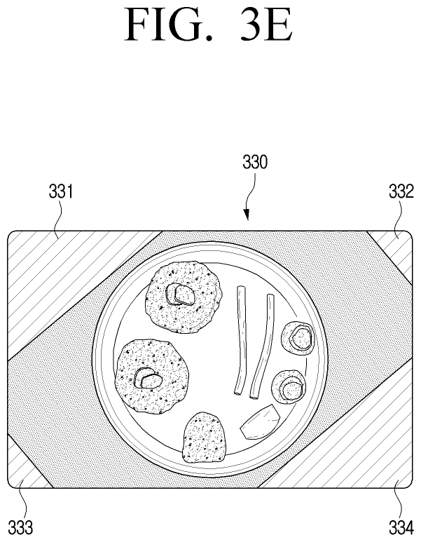

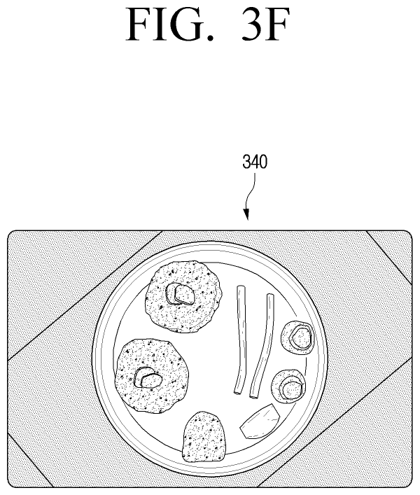

One of the plurality of images may be an image 310 shown in FIG. 3A. In this case, the one image 310 may be an image captured 6 seconds after the reference image 210 was captured. In addition, the rotation angle of the inner chamber at the time when the one image 310 is captured may be 60 degrees. In this case, the processor 160 may match the one image 310 with 60 degrees and store it in the memory 110.

Subsequently, the processor 160 may rotate each of the plurality of images in the second direction by a rotation angle that is matched to each of the plurality of images and stored. In this case, the processor 160 may rotate each of the plurality of images with reference to a center of each of the plurality of images.

In this case, the second direction may be a direction opposite to the first direction (i.e., the rotation direction of the inner chamber). For example, when the first direction is clockwise, the second direction may be counterclockwise.

For example, when the angle matched and stored with the first image of the plurality of images is 10 degrees, the processor 160 may rotate the first image by 10 degrees in the second direction.

Alternatively, when the angle matched and stored with the second image of the plurality of images is 20 degrees, the processor 160 may rotate the second image by 20 degrees in the second direction.

Referring to FIG. 3A, the angle that is matched and stored with one image 310 of the plurality of images may be 60 degrees. In this case, the processor 160 may rotate the one image 310 by 60 degrees counterclockwise, which is the direction opposite to the rotation direction of the inner chamber. Here, the image generated by rotating the one image 310 by 60 degrees counterclockwise may be an image 320 shown in FIG. 3B.

The processor 160 may obtain a plurality of cropped images by cropping the rotated each of plurality of images such that each of the plurality of rotated images corresponds to the reference image.

Specifically, the processor 160 may obtain the cropped images by cropping an area where each of the plurality of rotated images does not overlap with an area of the reference image in each of the plurality of rotated images.

For example, one image 320 among the plurality of rotated images and an area 321 of the reference image may be as shown in FIG. 3C. In this case, an area that overlaps with the area 321 of the reference image may refer to an area that is included in the area 321 of the reference image in the one image 320. Further, an area that does not overlap with the area 321 of the reference image may refer to an area that is not included in the area 321 of the reference image in the one image 320.

In this case, the processor 160 may obtain a cropped image 330 by cropping an area that does not overlap with the area 321 of the reference image in the one image 320 as shown in FIG. 3D.

In this case, the processor 160 may perform a correction to display blank areas 331, 332, 333, 334 of the cropped image 330 in a particular color as shown in FIG. 3E.

For example, the processor 160 may obtain a corrected image 340 by performing a correction to display blank areas 331, 332, 333, 334 of the cropped image 330 in black as shown in FIG. 3F.

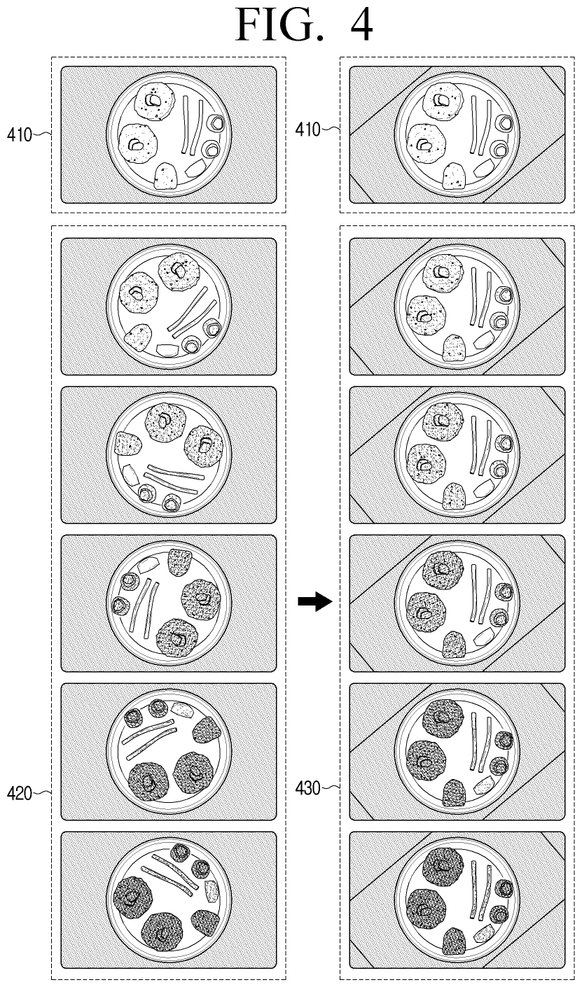

In other words, the processor 160 may perform the operation as described above for a reference image 410 and each of a plurality images 420 to obtain a plurality of corrected images 430 as shown in FIG. 4. In this case, the processor 160 may provide a time-lapse video including the reference image 410 and the plurality of corrected images 430.

According to the method described above, the position of the food may not change while the food is being cooked in the time-lapse video obtained by the cooking appliance with the rotating inner chamber. In other words, the present disclosure has the effect of generating the time-lapse video in the same phase as the initial time of the time-lapse video, so that the user can clearly check the cooking degree of the food while checking the time-lapse video.

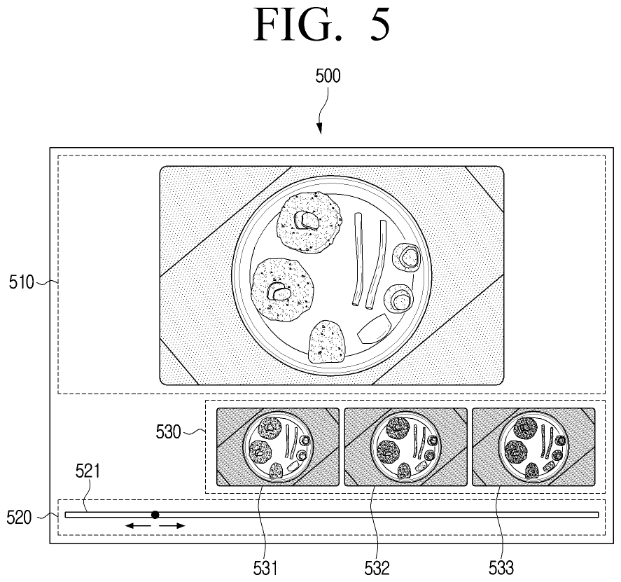

The time-lapse video may be provided in the form of a UI including a progress bar. Referring to FIG. 5, a UI 500 may include a playback area 510, a progress bar area 520, and a thumbnail area 530.

Here, the playback area 510 may be an area in which an image included in the time-lapse video is displayed.

The progress bar area 520 may include a progress bar 521 on the UI. In this case, the point in time at which the time-lapse video is displayed may be shifted via an input of touching the scroll of the progress bar 521. Meanwhile, the progress bar 521 is only an example, and the user may also use dials or buttons to move the time point of the time-lapse video.

The thumbnail area 530 may be located on one side of the progress bar 521. In this case, the thumbnail area may include a thumbnail corresponding to at least one of the reference image or the plurality of images.

Meanwhile, images 531, 532, 533 displayed in the thumbnails may correspond to a particular cooking degree.

Specifically, the processor 160 may identify an image corresponding to a particular cooking degree among the reference image and the plurality of corrected images. Subsequently, the processor 160 may generate a thumbnail using the image corresponding to the particular cooking degree.

Here, the processor 160 may obtain the cooking degree corresponding to each of the plurality of corrected images by inputting each of the plurality of corrected images into an artificial intelligence model stored in the memory 110. The processor 160 may then identify at least one corrected image corresponding to a preset cooking degree (e.g., rare, medium, well-done).

For example, the processor 160 may identify an image 531 corresponding to rare, an image 532 corresponding to medium, and an image 533 corresponding to well-done among the reference image and the plurality of corrected images.

In this case, the thumbnails may be displayed only with the image 531, 532, 533, but this is only an example, and information about the cooking degree or cooking time of the food may be displayed around the thumbnail images 531, 532, 533. For example, text information such as rare, medium, well-done may be displayed on one side of the thumbnails. Alternatively, information about the time when the images 531, 532, 533 corresponding to the thumbnails were captured may be displayed on one side of the thumbnails.

When a user input of selecting one of the thumbnail images 531, 532, 533 in the time-lapse video is obtained, a screen corresponding to the selected image may be played on the playback area 510.

For example, when the image 531 corresponding to rare is selected, the image at the time when the image 531 corresponding to rare was captured in the time-lapse video may be played on the playback area 510.

In this case, the image input to the artificial intelligence model and the image identified by the processor 160 may be one of the plurality of corrected images, but this is only an example, and may be an uncropped image or a cropped image.

According to an embodiment, once the time-lapse video is generated, the processor 160 may transmit information for displaying the time-lapse video to a user terminal device. In this case, the processor 160 may transmit the information for displaying the time-lapse video to an external server for controlling the user terminal device.

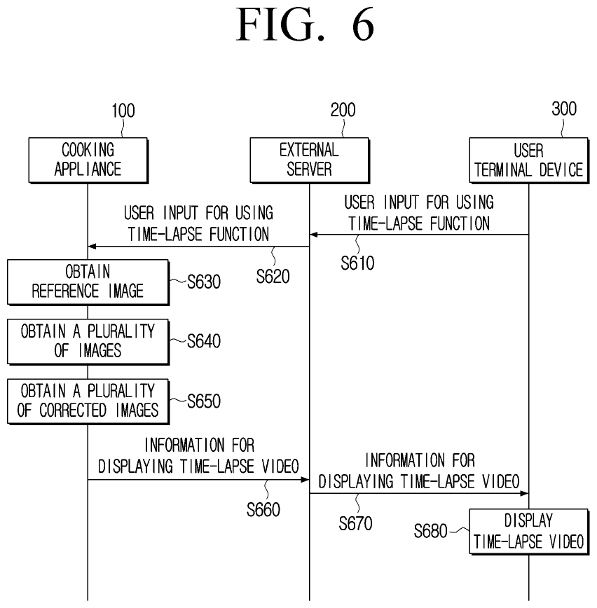

FIG. 6 is a sequence view provided to explain an operation of a cooking appliance according to an embodiment.

Specifically, referring to FIG. 6, a user terminal device 300 may transmit a user input for using a time-lapse function to an external server 200. In this case, the user terminal device 300 may transmit and receive data to and from the external server via an application for controlling the cooking appliance 100.

The external server 200 may transmit a user input for using the time-lapse function to the cooking appliance 100.

The cooking appliance 100 obtains a reference image (S630), and may obtain a plurality of images (S640).

Based on the reference image and the plurality of images, the cooking appliance 100 may obtain a plurality of corrected images (S650).

When the plurality of corrected images are obtained, the cooking appliance 100 may transmit information for displaying a time-lapse video to the external server 200 (S660).

The external server may then transmit information for displaying the time-lapse video to the user terminal device 300.

Subsequently, the user terminal device 300 may display the time-lapse video via a display on the user terminal device 300. In this case, the displayed time-lapse video may be as shown in FIG. 5.

Meanwhile, although the cooking appliance 100 may control the time-lapse video to be displayed on the user terminal device 300 via the external server 200, this is only an example, and the cooking appliance 100 may transmit and receive data to and from the user terminal device 300 without the external server 200 and control the user terminal device 300 to display the time-lapse video.

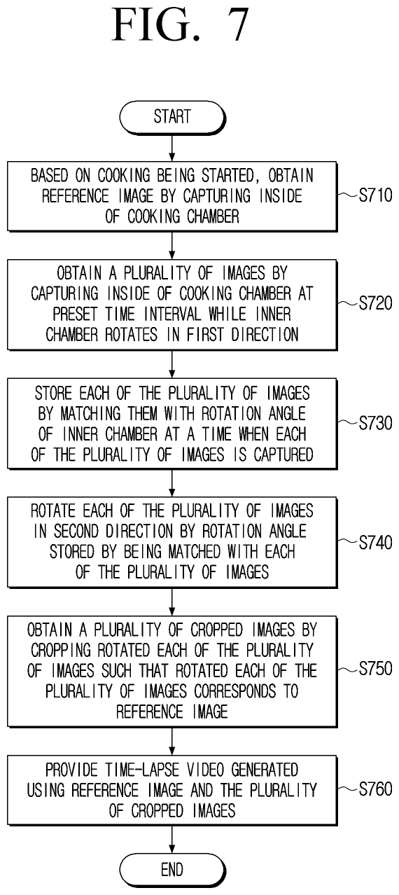

FIG. 7 is a view provided to explain a controlling method of a cooking appliance according to an embodiment.

Once cooking starts, the cooking appliance 100 may obtain a reference image by capturing an inside of a cooking chamber (S710).

Further, the cooking appliance 100 may obtain a plurality of images by capturing the inside of the cooking chamber at a preset time interval while an inner chamber is rotating in the first direction (S720).

The cooking appliance 100 may store each of the plurality of images by matching each of the plurality of images with a rotation angle of the inner chamber at the time when each of the plurality of images is captured (S730).

The cooking appliance 100 may then rotate each of the plurality of images in the second direction by a rotation angle that is matched with each of the plurality of images and stored (S740). In this case, the second direction may be a direction opposite to the first direction.

Subsequently, the cooking appliance 100 may obtain a plurality of cropped images by cropping each of the rotated plurality of images such that each of the rotated plurality of images corresponds to the reference image (S750). In this case, the cooking appliance 100 may obtain the cropped images by cropping the area where each of the plurality of rotated images does not overlap with the area of the reference image in each of the plurality of rotated images.

The cooking appliance 100 may then provide a time-lapse video using the reference image and the plurality of cropped images (S760).

In this case, the cooking appliance 100 may perform a correction to display blank areas in each of the plurality of cropped images in black to obtain a plurality of corrected images. Then, the cooking appliance 100 may provide a time-lapse video including the reference image and the plurality of corrected images.

In this case, the time-lapse video may include a progress bar and a thumbnail corresponding to at least one of the plurality of images may be displayed on one side of the progress bar.

The cooking device 100 may identify an image corresponding to a preset cooking degree among the plurality of images, and in this case, the time-lapse video may include a thumbnail including the image corresponding to the preset cooking degree.

Subsequently, the cooking appliance 100 may transmit information for displaying the time-lapse video to the user terminal device 300.

The at least one processor may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The at least one processor may control one or any combination of the other components of the electronic apparatus, and may perform communication-related operations or data processing. The at least one processor may execute one or more programs or instructions stored in memory. For example, the at least one processor may perform a method according to an embodiment by executing one or more instructions stored in the memory.

When a method according to an embodiment includes a plurality of operations, the plurality of operations may be performed by one processor or by a plurality of processors. For example, when a first operation, a second operation, and a third operation are performed by the method according to an embodiment, all of the first operation, the second operation, and the third operation may be performed by the first processor, or the first operation and the second operation may be performed by the first processor (e.g., a general-purpose processor) and the third operation may be performed by the second processor (e.g., an artificial intelligence-dedicated processor).

The at least one processor may be implemented as a single core processor including a single core, or as one or more multicore processors including a plurality of cores (e.g., homogeneous multicore or heterogeneous multicore). When the at least one processor is implemented as a multicore processor, each of the plurality of cores included in the multicore processor may include internal memory of the processor, such as cache memory and an on-chip memory, and a common cache shared by the plurality of cores may be included in the multicore processor. Each of the plurality of cores (or some of the plurality of cores) included in the multi-core processor may independently read and perform program instructions to implement the method according to an embodiment, or all (or some) of the plurality of cores may be coupled to read and perform program instructions to implement the method according to an embodiment.

When a method according to an embodiment includes a plurality of operations, the plurality of operations may be performed by one core of a plurality of cores included in a multi-core processor, or may be performed by a plurality of cores. For example, when a first operation, a second operation, and a third operation are performed by a method according to an embodiment, all of the first operation, the second operation, and the third operation may be performed by the first core included in the multi-core processor, or the first operation and the second operation may be performed by the first core included in the multi-core processor and the third operation may be performed by the second core included in the multi-core processor.

In the embodiments of the present disclosure, the processor may mean a system-on-chip (SoC) in which at least one processor and other electronic components are integrated, a single-core processor, a multi-core processor, or a core included in a single-core processor or multi-core processor, and here, the core may be implemented as CPU, GPU, APU, MIC, DSP, NPU, hardware accelerator, or machine learning accelerator, etc., but the core is not limited to the embodiments of the present disclosure.

Meanwhile, terms “˜er/or” or “module” used in the disclosure may include units configured by hardware, software, or firmware, and may be used interchangeably with terms such as logics, logic blocks, parts, circuits, or the like. The “˜er/or” or “module” may be an integrally configured part or a minimum unit performing one or more functions or a part thereof. For example, the module may be configured by an application-specific integrated circuit (ASIC).

Meanwhile, according to an embodiment, the above-described various embodiments may be implemented as software including instructions stored in machine-readable storage media, which can be read by machine (e.g.: computer). The machine refers to a device that calls instructions stored in a storage medium, and can operate according to the called instructions, and the device may include a display device (e.g., electronic apparatus A) according to the aforementioned embodiments. In case an instruction is executed by a processor, the processor may perform a function corresponding to the instruction by itself, or by using other components under its control. The instruction may include a code that is generated or executed by a compiler or an interpreter. The machine-readable storage medium may be provided in the form of a non-transitory storage medium. Here, the term ‘non-transitory’ means that the storage medium is tangible without including a signal, and does not distinguish whether data are semi-permanently or temporarily stored in the storage medium.

In addition, according to an embodiment, the above-described methods according to the various embodiments may be included and provided in a computer program product. The computer program product may be traded as a product between a seller and a purchaser. The computer program product may be distributed in a form of a storage medium (e.g., a compact disc read only memory (CD-ROM)) that may be read by the machine or online through an application store (e.g., PlayStore™). In case of the online distribution, at least a portion of the computer program product may be at least temporarily stored in a storage medium such as a memory of a server of a manufacturer, a server of an application store, or a relay server or be temporarily generated.

The components (e.g., modules or programs) according to various embodiments described above may include a single entity or a plurality of entities, and some of the corresponding sub-components described above may be omitted or other sub-components may be further included in the various embodiments. Alternatively or additionally, some components (e.g., modules or programs) may be integrated into one entity and perform the same or similar functions performed by each corresponding component prior to integration. Operations performed by the modules, the programs, or the other components according to the various embodiments may be executed in a sequential manner, a parallel manner, an iterative manner, or a heuristic manner, or at least some of the operations may be performed in a different order or be omitted, or other operations may be added.

1. A cooking appliance comprising:
a cooking chamber in which an inner chamber is rotatable;
a camera;
a memory to store at least one instruction; and
at least one processor to be connected to the memory to control the cooking appliance, so that while the at least one processor is connected to the memory, the at least one processor executes the at least one instruction to:
based on cooking being started, obtain a reference image of an inside of the cooking chamber captured by the camera;
obtain a plurality of images of the inside of the cooking chamber, captured by the camera, at a preset time interval while the inner chamber rotates in a first direction;
store the plurality of images by matching the plurality of images with a rotation angle of the inner chamber at a time the plurality of images are captured, respectively;
obtain a plurality of rotated images by rotating the plurality of images in a second direction by a rotation angle stored that matches the plurality of images, the second direction being opposite to the first direction;
obtain a plurality of cropped images by cropping the plurality of rotated images such that the plurality of rotated images correspond to the reference image; and
provide a time-lapse video using the reference image and the plurality of cropped images.

2. The cooking appliance as claimed in claim 1, wherein the at least one processor is configured to obtain the plurality of cropped images by cropping an area of the plurality of rotated images that does not overlap with an area of the reference image in the plurality of rotated images.

3. The cooking appliance as claimed in claim 1, wherein the at least one processor is configured to:
obtain a plurality of corrected images by performing a correction of displaying a blank area of the plurality of cropped images in black; and
provide a time-lapse video including the reference image and the plurality of corrected images.

4. The cooking appliance as claimed in claim 1, wherein the time-lapse video includes a progress bar, and
wherein a thumbnail corresponding to at least one of the plurality of images is displayed on one side of the progress bar.

5. The cooking appliance as claimed in claim 1, wherein the at least one processor is configured to identify an image corresponding to a preset cooking degree among the plurality of images.

6. The cooking appliance as claimed in claim 5, wherein the time-lapse video includes a thumbnail including an image corresponding to the preset cooking degree.

7. The cooking appliance as claimed in claim 1, wherein the at least one processor is configured to transmit information for displaying the time-lapse video to a user terminal device.

8. A controlling method of a cooking appliance, the controlling method comprising:
based on cooking being started, obtaining a reference image of an inside of a cooking chamber captured by a camera;
obtaining a plurality of images of the inside of the cooking chamber at a preset time interval while an inner chamber of the cooking chamber rotates in a first direction;
storing the plurality of images by matching the plurality of images with a rotation angle of the inner chamber at a time the plurality of images are captured;
obtain a plurality of rotated images by rotating the plurality of images in a second direction by a rotation angle stored that matches the plurality of images, the second direction being opposite to the first direction;
obtaining a plurality of cropped images by cropping the plurality of rotated images such that the plurality of rotated images correspond to the reference image; and
providing a time-lapse video using the reference image and the plurality of cropped images

9. The controlling method as claimed in claim 8, wherein the obtaining a plurality of cropped images comprises obtaining the plurality of cropped images by cropping an area where each of the plurality of rotated images does not overlap with an area of the reference image in each of the plurality of rotated images.

10. The controlling method as claimed in claim 8, further comprising:
obtaining a plurality of corrected images by performing a correction of displaying a blank area of each of the plurality of cropped images in black; and
wherein the providing a time-lapse video comprises providing a time-lapse video including the reference image and the plurality of corrected images.

11. The controlling method as claimed in claim 8, wherein the time-lapse video includes a progress bar, and
wherein a thumbnail corresponding to at least one of the plurality of images is displayed on one side of the progress bar.

12. The controlling method as claimed in claim 8, further comprising:
identifying an image corresponding to a preset cooking degree among the plurality of images.

13. The controlling method as claimed in claim 12, wherein the time-lapse video includes a thumbnail including an image corresponding to the preset cooking degree.

14. The controlling method as claimed in claim 8, further comprising:
transmitting information for displaying the time-lapse video to a user terminal device.

15. A non-transitory computer-readable recording medium including a program that executable to perform a controlling method of a cooking appliance, the controlling method comprises:
based on cooking being started, obtaining a reference image of an inside of a cooking chamber captured by a camera;
obtaining a plurality of images of the inside of the cooking chamber at a preset time interval while an inner chamber of the cooking chamber rotates in a first direction;
storing the plurality of images by matching each of the plurality of images with a rotation angle of the inner chamber at a time when the plurality of images are captured, respectively;
obtain a plurality of rotated images by rotating the plurality of images in a second direction by a rotation angle stored that matches the plurality of images, the second direction being opposite to the first direction;
obtaining a plurality of cropped images by cropping the plurality of rotated images such that the plurality of rotated images correspond to the reference image; and
providing a time-lapse video using the reference image and the plurality of cropped images.
